(19) United States
(12) Patent Application Publication
(10) Pub. No.: US 2008/0020877 A1
(43) Pub. Date: Jan. 24, 2008

(54) Device For Securing And Tensioning a Unit That is Insertable Into a Belt Drive

(75) Inventor: Michael Bogner, Eckental (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/576,608

(22) PCT Filed: Sep. 13, 2005
(86) PCT No.: PCT/EP05/09814

§ 371 Date: Aug. 30, 2007

(30) Foreign Application Priority Data
Oct. 5, 2004 (DE) 10 2004 048 284.5

(51) Int. Cl. F16H 7/08

(52) U.S. Cl. 474/110

(57) ABSTRACT

A device for securing and tensioning a unit of an internal combustion engine that can be inserted into a belt drive is provided. The device includes at least one retaining element which is fixable or fixed in a positive and/or non-positive fit to the generator or starter-generator. A tensioning element which is used to tension the belt drive can be applied to or is arranged on the retaining element.

### FIELD OF THE INVENTION

The invention relates to a device for securing and tensioning a unit, which can be inserted into a belt drive, wherein the device comprises at least one retaining element, which can be fixed or is fixed in a positive and/or non-positive fit to the unit.

### BACKGROUND OF THE INVENTION

In WO 03/012960, an electrical machine, such as a generator, is described, which can be adapted to different internal combustion engines. For this purpose, removable attachment devices are provided, in order to connect the generator rigidly to the motor. This device is suitable, in particular, for the replacement part market, because a few basic types of generators can be adapted by means of different attachment devices to a large number of internal combustion engines. The belt drive must be tensioned separately from the attachment of the unit.

### SUMMARY OF THE INVENTION

The invention is based on the objective of providing a device with an expanded field of use.

To meet this objective, for a device for securing and tensioning a unit of the type noted above, it is provided according to the invention that a tensioning element for tensioning the belt drive can be attached or is attached to the retaining element.

The invention allows extensive standardization and restriction to a few types of units, which can be adapted with the corresponding retaining and tensioning element to different installation relationships. The retaining element and the tensioning element form an attachment device, which can be mounted separately from the unit. Because this attachment device is separate from the unit, it is possible to provide the retaining element with the tensioning element as a modular, prefabricated assembly, which can be mounted on the housing of an internal combustion engine. In a second, separate step, the unit can be mounted independent of the attachment device. This produces the great advantage that the previously typical wide array of variants can be reduced to a few standard sizes, which can be mounted by means of the attachment device according to the invention. The term “unit” used here comprises, for example, generators, starter generators, air-conditioner compressors, steering booster pumps, and similar components of belt drives.

It is especially preferred that the tensioning element is a mechanical and/or hydraulic tensioning element. Such belt tensioners are known, and comprise, for the most part, a spring element, which is combined with a damping element. If such tensioning elements are used, the correct tension can be applied to the belt, which runs on a pulley of the unit, in each operating state.

The attachment device according to the invention can be embodied so that the tensioning element can be fixed or is fixed, on one hand, to the retaining element and, on the other hand, to the internal combustion engine. For such a design, the unit is supported by the tensioning element on the internal combustion engine. It is especially preferred that the retaining element has a bearing eye, by means of which the retaining element can be fixed to the housing of the internal combustion engine.

According to another construction of the invention, it can also be provided that the retaining element comprises a first holder, which connects the unit to the housing of the internal combustion engine, and a second, separate holder, which connects the unit to the tensioning element. For this construction, separate holders are allocated to the two attachment points of the unit.

The device according to the invention for securing and tensioning a unit can have a clamping connection, by means of which the retaining element and the unit can be connected to each other. This clamping connection can be constructed, for example, as a dovetail joint. Other clamping connections are also conceivable, for example, a clamping block can be used, in order to connect the two parts detachably to each other.

In the device according to the invention, it can be provided that the unit can be connected to or can be slid on the retaining element in the radial or axial direction relative to its housing. The type of attachment can thus be selected optimally as a function of the corresponding installation relationships.

The device according to the invention for securing and tensioning a unit can further comprise a locking plate, which secures the unit after installation from sliding out of the retaining element.

### BRIEF DESCRIPTION OF THE DRAWINGS

Additional advantages and details of the invention are explained using embodiments with reference to the figures. The figures are schematic drawings and show:

FIG. 1 a view of a first embodiment of a device according to the invention for securing and tensioning a unit with a retaining element and a tensioning element;

FIG. 2 a perspective view of the device shown in FIG. 1;

FIG. 3 a perspective view of the retaining element with inserted unit;

FIG. 4 another perspective view of the retaining element with inserted unit;

FIG. 5 an exploded view of the retaining element and the unit, which is secured by a locking plate;

FIG. 6 another perspective view of the arrangement from FIG. 5; and

FIG. 7 a view of an embodiment, in which the retaining element comprises two separate holders.

### DETAILED DESCRIPTION OF THE DRAWINGS

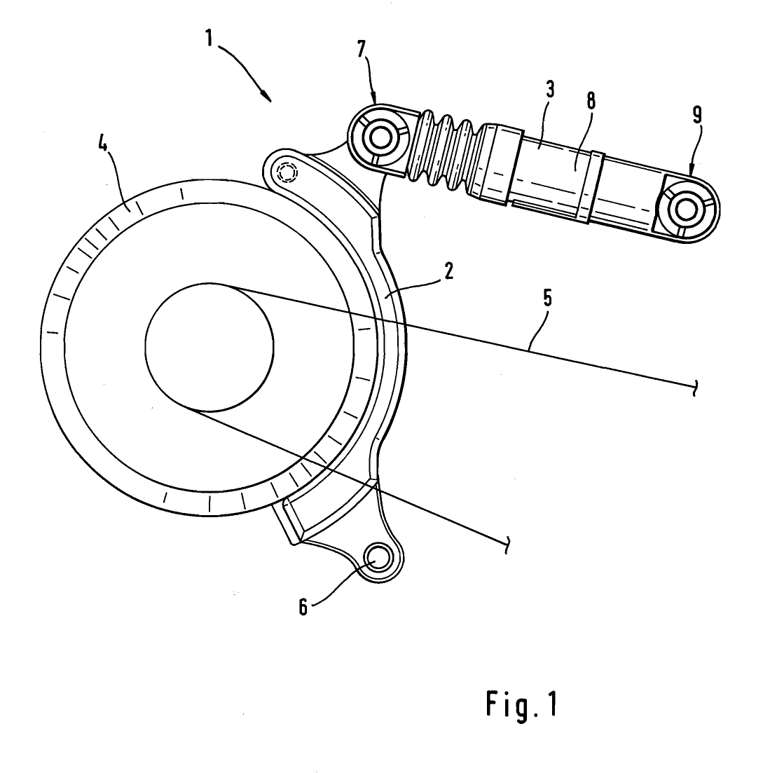

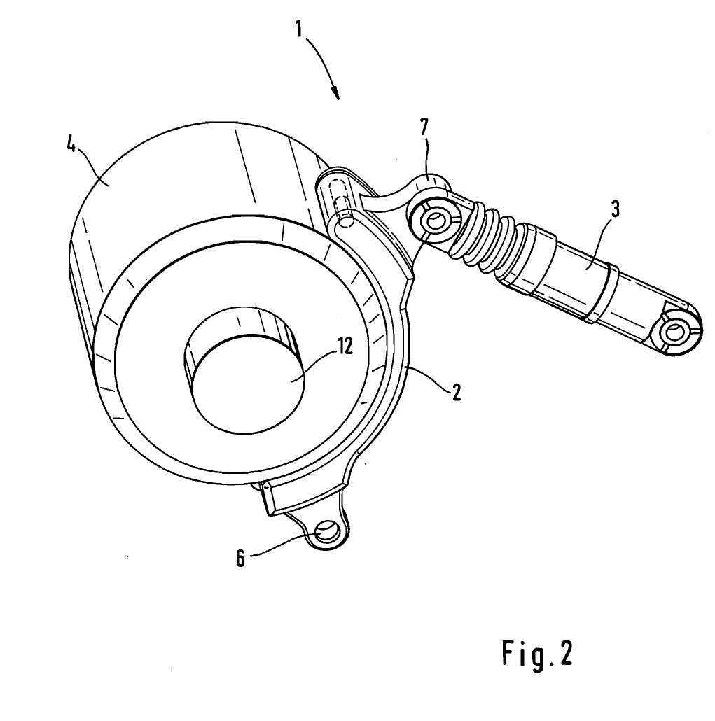

FIGS. 1 and 2 show a device for securing a unit embodied as a generator or a starter generator with a retaining element and a tensioning element.

The attachment device is suitable equally for generators and for starter generators, in addition also for air-conditioner compressors or steering booster pumps. Generators are driven by the internal combustion engine and generate electrical energy required for operating a motor vehicle. Starter generators can be operated either as a generator or as a motor. If a starter generator is operated as a generator, it is driven by the internal combustion engine via the belt drive and generates electrical energy. The starter generator, however, can also be operated as a motor, in order to start the internal combustion engine. In this case, a separate starter motor can be omitted.

FIGS. 1 and 2 show an attachment device 1, which comprises a retaining element 2 and a tensioning element 3. By means of the attachment device 1, a starter generator 4 is fixed to a not-shown internal combustion engine, wherein the starter generator 4 is driven via a belt 5 or drives the belt 5.

The retaining element 2 is provided as a curved retaining clip and is adapted to the outer contours of the starter generator 4. By means of a first bearing eye 6, the retaining element 2 can be fixed in an articulating manner to the housing of the internal combustion engine. The tensioning element 3 is fixed in an articulating way to a second bearing eye 7 of the retaining element 2. The tensioning element 3 is provided as a hydraulic tensioning element 8, which generates, on one hand, a certain tension on the belt 5, in that it presses the starter generator 4 out of the belt drive, and, on the other hand, it is used for damping resulting vibrations on the belt drive. The other end 9 of the tensioning element 8 can be fixed in an articulating manner to the housing of the internal combustion engine with its bearing eye directly or via a separate retaining device. The retaining element 2 forms a prefabricated assembly, which can be mounted before the installation of the starter generator 4, together with the tensioning element 3.

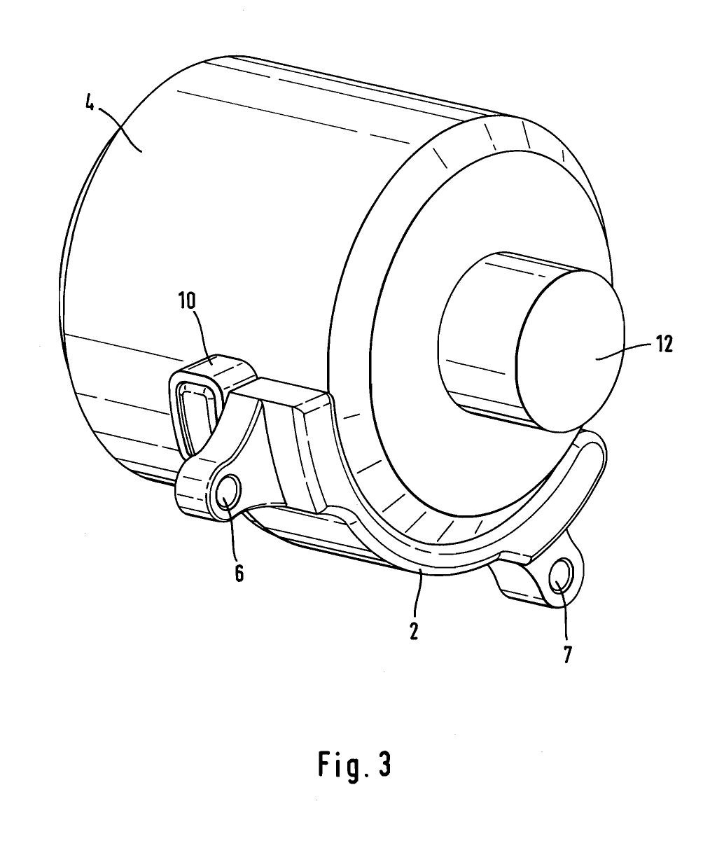

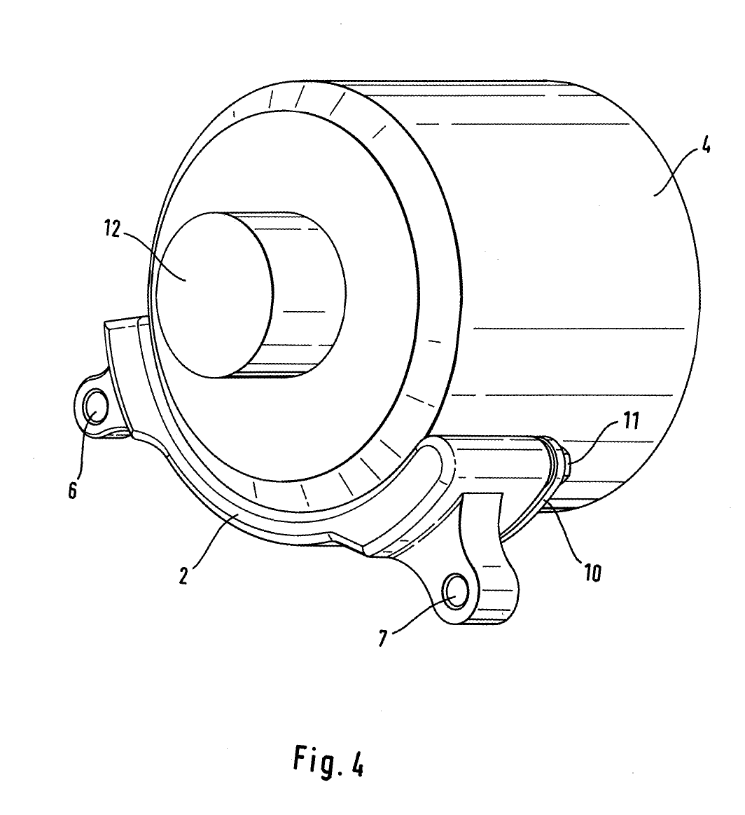

FIGS. 3 and 4 show the retaining element with the inserted starter generator. For reasons of clarity, the tensioning element 3 is not shown.

The starter generator 4 and the retaining element 2 can be connected to each other via a dovetail joint. After installation, the starter generator 4 is connected rigidly to the retaining element 2, which surrounds the starter generator 4 in the peripheral direction.

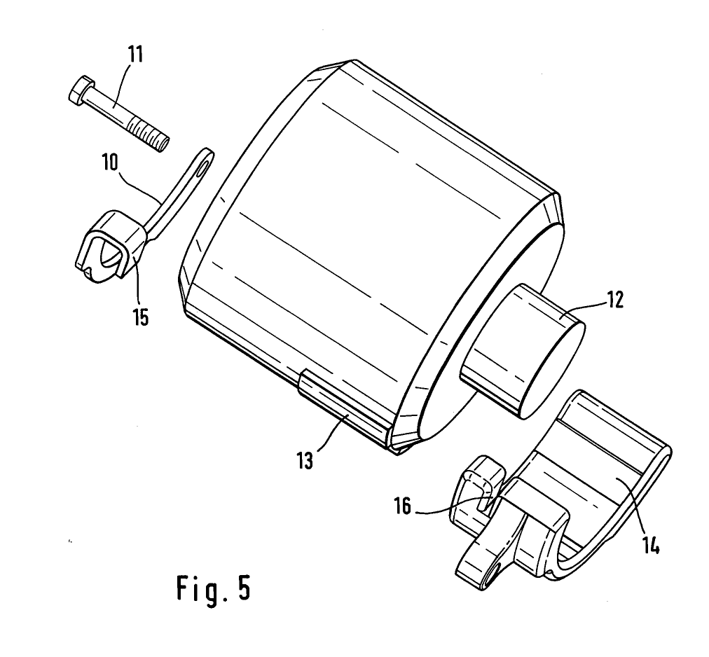

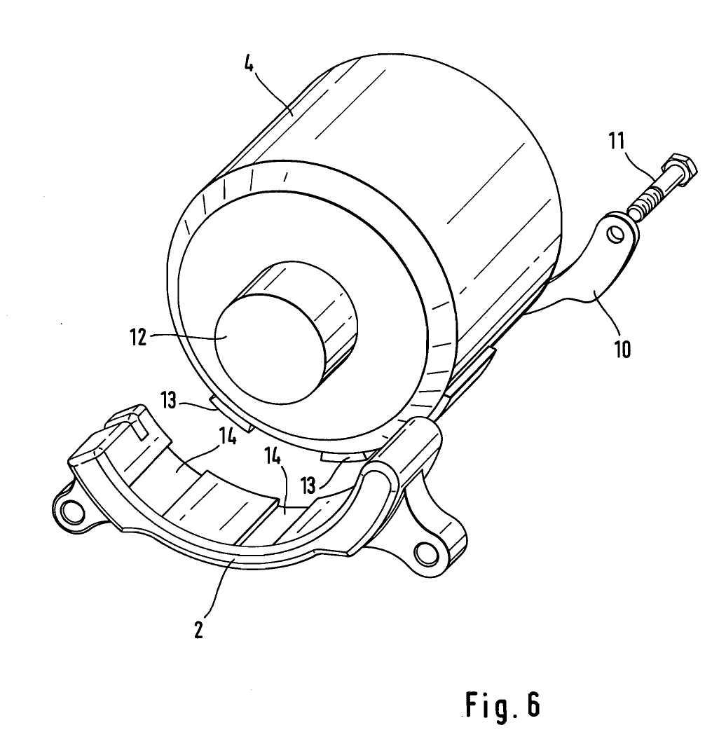

FIGS. 5 and 6 show exploded views of the retaining element and the starter generator. The associated tensioning element 3 is not shown.

It can be seen that the retaining element also comprises a locking plate 10, which can be secured with a screw 11.

The starter generator 4 has three dovetail-shaped projections 13, which are distributed over the periphery and which can be pushed into corresponding equally formed dovetail grooves 14 of the retaining element 2, on the side, on which the schematically shown belt pulley 12 is located. In the shown embodiment, the starter generator 4 can be pushed into the retaining element 2 in the axial direction. To prevent the starter generator 4 from sliding out of the retaining element 2, the locking plate 10 is then screwed from the rear side against the retaining element 2.

The locking plate has a clip 15, which is hooked into a groove 16 of the retaining element 2. The locking plate 10 is secured with the screw 11, which can be screwed into a thread of the retaining element 2.

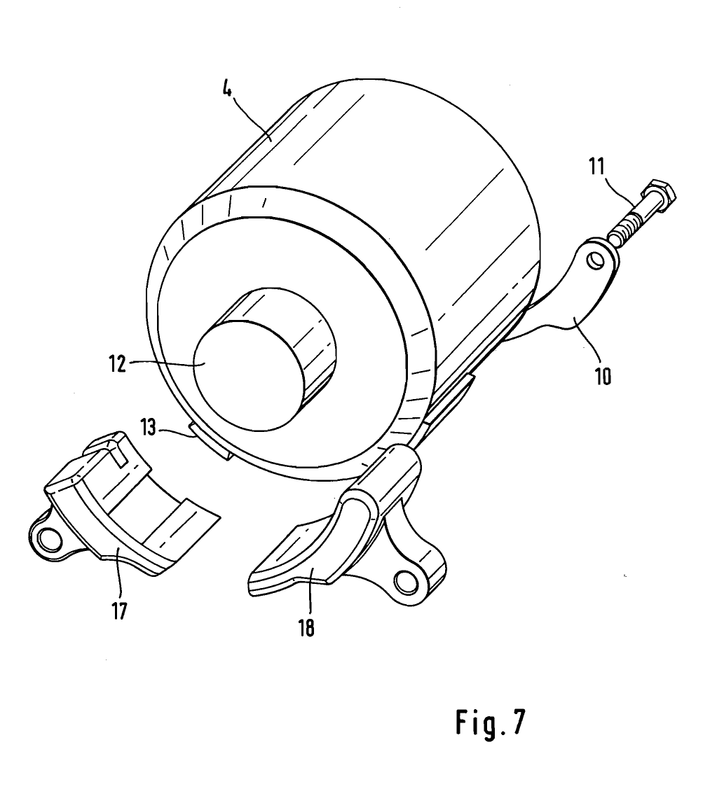

FIG. 7 shows another embodiment, in which the retaining element 2 comprises separate holders.

Alternatively to the preceding embodiments, the starter generator 4 is held by a first holder 17 and a second holder 18. Each of the holders 17, 18 has a dovetail groove, into which a dovetail-shaped projection of the starter generator 4 can be inserted. Analogous to the first embodiment, one of the holders can be fixed in an articulating way to the housing of the internal combustion engine. A tensioning element can be fixed to the bearing eye of the other holder.

### REFERENCE NUMBERS

1 Attachment device
2 Retaining element
3 Tensioning element
4 Starter generator
5 Belt
6 Bearing eye
7 Bearing eye
8 Tensioning element
9 End
10 Locking plate
11 Screw
12 Belt pulley
13 Projection
14 Dovetail groove
15 Clip
16 Groove
17 Holder
18 Holder

1. Device for securing and tensioning a unit, which can be inserted into a belt drive, for an internal combustion engine, the device comprises at least one retaining element, which can be fixed or is fixed in a positive and/or non-positive fit to the unit, and a tensioning element for tensioning the belt drive is attachable or attached to the retaining element.

2. Device according to claim 1, wherein the tensioning element is a mechanical and/or hydraulic tensioning element.

3. Device according to claim 1, wherein the tensioning element is fixable or fixed, on one hand, to the retaining element and, on the other hand, to the internal combustion engine.

4. Device according to claim 1, wherein the retaining element has a bearing eye, to which the tensioning element is fixable or fixed in an articulating manner.

5. Device according to claim 1, wherein the retaining element has another bearing eye, by which the device can be fixed to the internal combustion engine in an articulating manner.

6. Device according to claim 1, wherein the retaining element and the tensioning element are a preassembled unit.

7. Device according to claim 1, wherein the retaining element comprises a first holder, which connects the unit to the housing of the internal combustion engine, and a second holder, which connects the unit to the tensioning element.

8. Device according to claim 1, wherein the retaining element and the unit can be connected to each other via a connecting joint.

9. Device according to claim 1, wherein the unit can be connected to the retaining element or can be slid onto the retaining element in a radial or an axial direction with reference to the housing.

10. Device according to claim 1, wherein a locking plate is provided, in order to secure the unit after installation in the retaining element.

11. Device according to claim 1, wherein the unit is a generator, a starter generator, a steering booster pump or an air-conditioner compressor.
